(19) United States
(12) Patent Application Publication
(10) Pub. No.: US 2024/0040177 A1
(43) Pub. Date: Feb. 1, 2024

(54) DIGITAL VIDEO DELIVERY ALARM COMPUTER SYSTEM

(71) Applicant: Dice Corporation, Bay City, MI (US)

(72) Inventors: Clifford V. DICE, Midland, MI (US); Kevin P. KILBORN, Bay City, MI (US)

(21) Appl. No.: 17/876,062

(22) Filed: Jul. 28, 2022

(51) Int. Cl. H04N 21/2662

(52) U.S. Cl. CPC H04N 21/2662

(57) ABSTRACT

A computer readable medium having non-transitory memory for storing machine instructions that are to be executed by a digital video delivery alarm computer. The machine instructions when executed by the digital video alarm computer implement the following function: determining a receipt frame rate for receiving digital video frames including first and second digital video frames by the digital video delivery alarm computer from a digital video transmitting computer having a transmit frame rate for transmitting digital video frames including the first and second digital video frames. The functions further include adjusting a display frame rate for displaying the digital video frames including the first and second digital video frames through the digital video delivery alarm computer. The display frame rate is less than the transmit frame rate. The digital video frames are associated with a digital video event.

### TECHNICAL FIELD

This invention relates to a digital video delivery alarm computer system.

### BACKGROUND

Alarm monitoring computer systems have been developed and implemented. Conventional alarm monitoring computer systems are typically limited by bandwidth, costs, and other constraints. These constraints have limited the delivery of digital video through alarm monitoring computer systems. Current proposals have not delivered solutions that adequately display digital video through an alarm monitoring computer system constrained by relatively low bandwidth.

### SUMMARY

In one embodiment, a computer readable medium having non-transitory memory for storing machine instructions that are to be executed by a digital video delivery alarm computer is disclosed. The machine instructions when executed by the digital video alarm computer implement the following function: determining a receipt frame rate for receiving digital video frames including first and second digital video frames by the digital video delivery alarm computer from a digital video transmitting computer having a transmit frame rate for transmitting digital video frames including the first and second digital video frames. The functions further include adjusting a display frame rate for displaying the digital video frames including the first and second digital video frames through the digital video delivery alarm computer. The display frame rate is less than the transmit frame rate. The digital video frames are associated with a digital video event.

In another embodiment, a computer readable medium having non-transitory memory for storing machine instructions that are to be executed by a digital video delivery alarm computer is disclosed. The machine instructions when executed by the digital video alarm computer implement the following functions: receiving a digital video frame. The functions further include storing the digital video frame in a video cache upon determining the digital video frame is a complete digital video frame. The functions also include accessing the digital video frame to render the digital video frame to create a rendered digital video frame. The functions also include displaying the rendered digital video frame.

In yet another embodiment, a computer readable medium having non-transitory memory for storing machine instructions that are to be executed by a digital video delivery alarm computer is disclosed. The machine instructions when executed by the digital video alarm computer implement the following function: receiving a first video stream and a second video stream. The first video stream includes a number of first digital video frames and the second video stream includes a number of second digital video frames. The functions further include selectively displaying the number of first digital video frames in a first window at a first display frame rate such that the displayed first digital video frames in the number of first digital video frames are complete first digital video frames. The functions also include selectively displaying the number of second digital video frames in a second window at a second display frame rate such that the displayed second digital video frames in the number of second digital video frames are complete second digital video frames.

### BRIEF DESCRIPTION OF THE DRAWINGS

FIG. 1 depicts a computer architecture for a digital alarm video provisioning computer system according to one embodiment.

FIGS. 2A and 2B depicts a sequence diagram of a digital video delivery alarm computer system according to one embodiment.

FIG. 3 depicts a graphical user interface (GUI) configured to display several windows where each window contains a live video feed rendered using one or more embodiments disclosed herein.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Live viewing of digital video on a device may be encumbered by bandwidth issues. Conventional digital video codecs (e.g., real time streaming protocol (RTSP) or (TCP)) can deliver digital video at a high frame rate across a high bandwidth network to a user's device (e.g., delivery of digital television programs to a user's television). While these conventional digital video codecs function properly within a high bandwidth ecosystem, incomplete frames may be received (e.g., pixilation) when the bandwidth does not support the high frame rate of the digital video being transmitted over the network.

Streaming digital video using a codec includes the transmission of key or reference digital video frames at intervals (e.g., regular or irregular intervals), and transmission of modification frames at intervals (e.g., regular or irregular intervals) between the intervals of transmission of key or reference digital video frames. Each of the modification frames includes data representing any changes in the frame from the key or reference frame. The data from a modification frame and its reference frame are used to reformat an image reflecting the complete image at the interval of the modification frame.

In many applications within the digital video alarm industry, the bandwidth required to deliver a high frame rate digital video may not be available or advisable due to cost constraints or other considerations. The digital video alarm system may include a digital video transmitting computer (e.g., a remote computer, a server computer, or a camera server) and a digital video receiving computer (e.g., a local computer or a user computer). Bandwidth may be an acute concern for digital video alarm industry applications when the digital video transmitting computer and the digital video receiving computer communicate through a cellular network (e.g., when the digital video receiving computer is a cell phone). What is needed is a digital video delivery computer system for displaying digital video associated with digital video alarms that compensates for bandwidth issues.

In one embodiment, a digital video delivery computer alarm system is disclosed in which the delivery of digital video to the system is adjusted based on the frame rate of receipt by the digital video transmitting computer. For instance, the frame rate of transmission may be higher than the frame rate of receipt. The digital video delivery system accounts for the frame rate of receipt such that only complete frames are delivered and displayed by the computer alarm system. This may sacrifice frame rate to retain integrity and quality of the digital video frames displayed. Therefore, the quality images may be displayed with a time delay to reduce the transmission frame rate to the receipt frame rate. Non-quality frames (e.g., those frames with incomplete data) are not displayed. An example of incomplete data is a frame where less than all the data is received regarding one or more pixels. In one or more embodiments, the key frames are displayed in systems where the key frame includes complete data. In one or more embodiments, at least each key frame is displayed. Additionally, complete modification frames may also be displayed. While this technique may not display every frame, the frames displayed are high quality and still give enough visual representation to detect an alarm event in the digital video stream (e.g., an intruder crossing the view of the digital camera). The techniques of one or more embodiments are applicable to display interfaces including many windows for different live video feeds while maintain the integrity of each video feed.

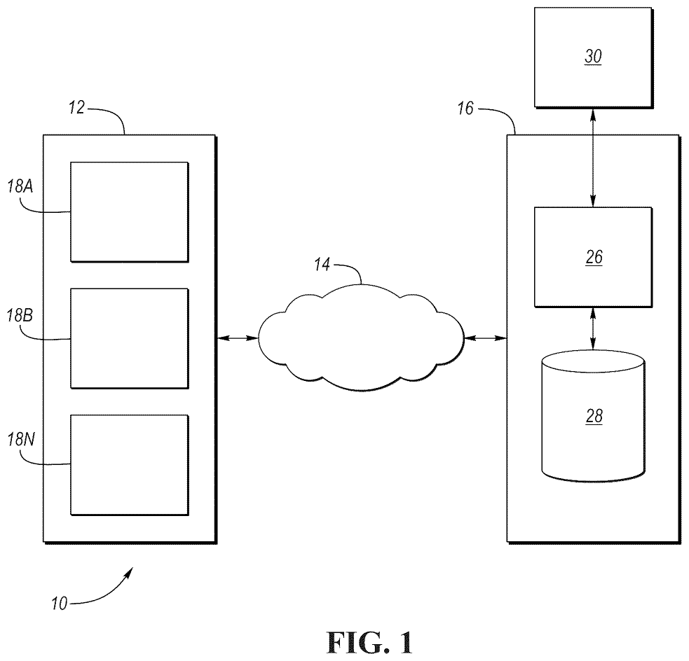

FIG. 1 depicts a computer architecture for digital video delivery alarm computer system 10. Computer system 10 includes client network 12, cloud server 14 (e.g., a digital video analytics server), and alarm monitoring server 16. Client network 12 includes network cameras 18A to 18N. Client network 12 is configured to transmit digital video clips and/or digital video frames to cloud server 14. A digital video clip may be comprised of a series of sequentially recorded digital video frames. A digital video frame may be a single digital image. Client network 12 may include a digital video recorder (DVR) or network video recorder (NVR) configured to receive digital video clips and/or digital video frames from one or more of network cameras 18A to 18N and to transmit the digital video clips and/or digital video frames to cloud server 14.

Alarm monitoring server 16 includes alarm monitoring module 26 and alarm monitoring database 28. Alarm monitoring module 26 may be configured to display graphical user interfaces (GUIs) on user device 30. User device 30 may be used by a user of digital video delivery alarm computer system 10. The user may be a subscriber of alarm services associated with digital video delivery alarm computer system 10. The user may be an operator at a central station or a client site. Alarm monitoring module 26 may be configured to receive digital video clips and/or digital video frames from cloud server 14. Alternatively or additionally, alarm monitoring module 26 may be configured to receive digital video clips and/or digital video frames directly from client network 12. Alarm monitoring database 28 may be configured to selectively store digital video clips and/or digital video frames received from cloud server 14.

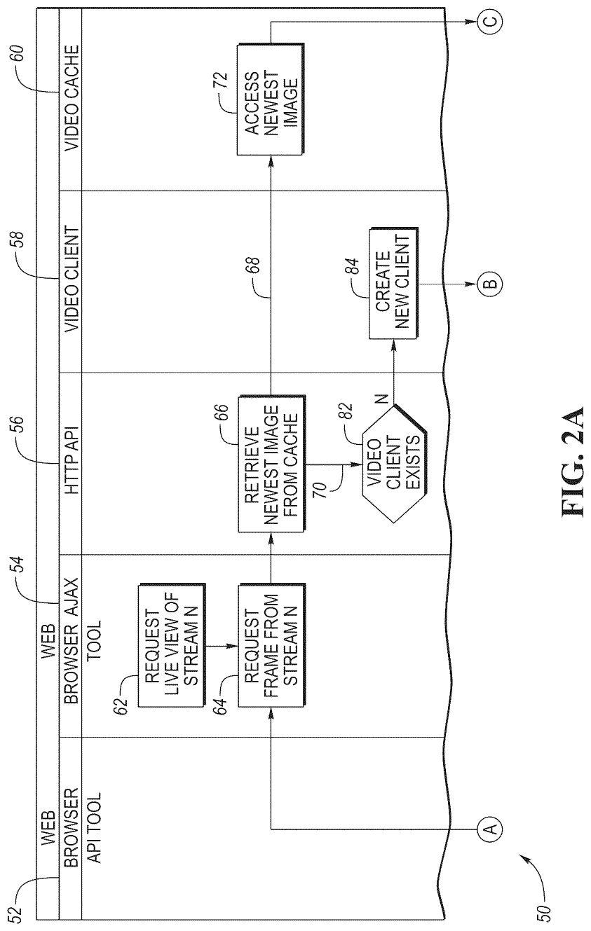

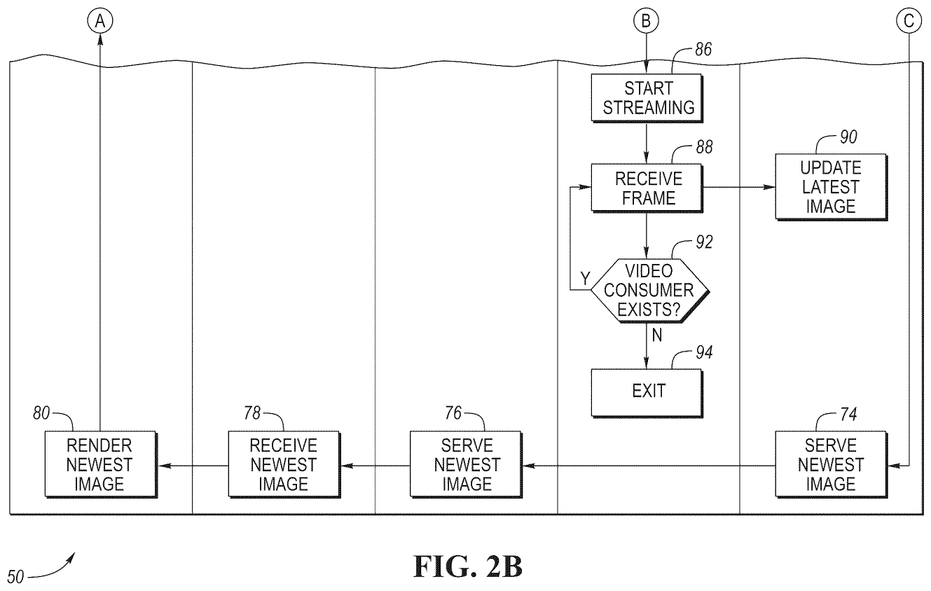

FIGS. 2A and 2B depicts sequence diagram of 50 of digital video delivery process protocol for an alarm computer system according to one embodiment. As shown in FIGS. 2A and 2B, the digital video delivery process protocol is executed by web browser application programming interface (API) tool 52, web browser asynchronous JavaScript and XML (AJAX) API tool 54, hypertext transfer protocol (HTTP) API tool 56, video client 58, and video cache 60.

Web browser API tool 52 may be executed on user device 30 via web browser software installed physically or virtually on user device 30. Web browser API tool 52 may be built into the web browser software. The features of web browser API tool 52 may be provided through the web browser software and/or web apps. Web browser API tool 52 may be configured to provide client-side (e.g., digital video delivery alarm computer system users) features. Web browser API tool 52 may be configured to receive and to transmit data and instructions from and to web browser AJAX tool 54. In one or more embodiments, web browser API tool 52 does not include any AJAX features or functionality, but rather relies on such AJAX features and/or functionality being provided by web browser AJAX tool 54.

Web browser AJAX API tool 54 may be executed on user device 30 via web browser software installed physically or virtually on user device 30. Web browser API tool 54 may be built into the web browser software. Web browser AJAX API tool 54 is configured to retrieve data (e.g., digital video) from HTTP or file transfer protocol (FTP) web server. Such retrieval may not depend on the format of the data being transmitted. In such embodiments, data can be retrieved independent of the format of the data being transmitted to AJAX API tool 54. Web browser AJAX API tool 54 may utilize features from JavaScript, extensible markup language (XML), dynamic hypertext markup language (DHTML), document object model (DOM), and/or Microsoft features. Web browser AJAX API tool 54 may be configured to receive and transmit data and instructions from and to HTTP API 56.

HTTP API tool 56 may be executed on user device 30 via web browser software installed physically or virtual on user device 30. HTTP API tool 56 may be configured to act as a communication protocol between a digital video transmitting computer (e.g., a remote computer, a server computer, or a camera server) and a digital video receiving computer (e.g., a local computer or a user computer). HTTP API tool 56 may be configured to endpoints (e.g., the digital video transmitting computer and the digital video receiving computer) as API gateways for HTTP requests to have access to a server (e.g., cloud server 14). In one or more embodiments, HTTP API tool 56 is configured to receive and to transmit data and instructions from and to video client 58.

In one or more embodiments, video client 58 is a computer application configured for live viewing, control, search and/or playback features for any camera connected to a network. Non-limiting examples of cameras include network cameras 18A to 18N as shown in FIG. 1. Non-limiting examples of a network include the Internet. Video client 58 may be physically installed on user device 30. Alternatively, video client 30 may be virtually served to user device 30 by cloud server 14. In such embodiments, HTTP API tool 56 may be utilized to provide access to network cameras 18A to 18N from video client 30. In one or more embodiments, video client 58 is configured to receive and to transmit data and instructions from and to HTTP API tool 56.

Video cache 60 is configured to store digital video (e.g., digital video clips and digital video frames). This digital video may be received from cloud server 14 or camera network 12. Video cache 60 is configured to retrieve the digital video more quickly for display than retrieval (i.e., transmission) from cloud server 14 or camera network 12. In one or more embodiments, implementation of an intermittent time delay permits retrieval of digital video directly from cache instead of directly from cloud server 14 or camera network 12 to use the bandwidth of digital video delivery alarm computer system more efficiently 10. Video cache 60 may be installed on user computer 30. Video cache 60 may be configured to receive and to transmit data and instructions to and from HTTP API tool 56, and video client 58.

In one embodiment, web browser application programming interface (API) tool 52, web browser asynchronous JavaScript and XML (AJAX) API tool 54, hypertext transfer protocol (HTTP) API tool 56, video client 58, and video cache 60 may be used in combination to provide a digital video delivery alarm system that reduces display of incomplete or missing digital frames through an alarm monitoring software user interface.

As depicted in operation 62 of digital video delivery process 50 as shown in FIGS. 2A and 2B, web browser AJAX tool 54 receives a request for a live view of video stream N. The live view of video stream N may be provided by one or more of network camera 18A to 18N. The video stream N may include digital video clips and/or digital video frames. The request may be transmitted by a user of the alarm computer system through a web browser.

As depicted in operation 64 of digital video delivery process 50 as shown in FIGS. 2A and 2B, web browser AJAX tool 54 transmits a request for a digital video frame from the video stream N in response to receiving a request for a live view of video stream N. The request for a digital video frame is transmitted from web browser AJAX tool 54 to HTTP API 56. Web browser AJAX tool 54 and HTTP API 56 may be loaded onto the same web browser application.

As depicted in operation 66 of digital video delivery process 50 as shown in FIGS. 2A and 2B, HTTP API 56 retrieves the most recent frame stored in video cache 60 by transmitting a request for the most recent frame to video cache 60 in a first branch depicted by arrow 68. HTTP API 56 transmits the request for the most recent frame in response to receiving a request for a digital video frame from web browser AJAX tool 54. Operation 66 also flows into a second branch depicted by arrow 70.

As depicted in operation 72 of digital video delivery process 50 as shown in FIGS. 2A and 2B, video cache 60 accesses the most recent frame stored in video cache 60 in response to receiving a request for a digital video frame from web browser AJAX tool 54. The most recent frame may be a reference frame or a modification frame. In one or more embodiments, non-quality frames (e.g., those frames with incomplete data) are not stored in video cache 60. Therefore, one or more key frames and/or modification frames may not be stored in video cache 60, thereby freeing up cache memory for frames with complete data. This process may create a time delay but ensure the caches frames include complete data.

In response to operation 72, video cache 60 serves the most recent frame stored in video cache 60 as depicted by operation 74. As depicted on FIGS. 2A and 2B, the most recent frame is served from video cache 60 to HTTP API 56.

As depicted in operation 76 of digital video delivery process 50 as shown in FIGS. 2A and 2B, HTTP API 56 serves the most recent frame to web browser AJAX tool 54. As shown in FIGS. 2A and 2B, video cache 60 indirectly serves the most recent image form video cache 60 to web browser AJAX tool 54.

As depicted in operation 78 of digital video delivery process 50 as shown in FIGS. 2A and 2B, web browser AJAX tool 54 receives the most recent frame from HTTP API 56. Web browser AJAX tool 54 is configured to transmit the most recent frame to web browser API tool 52.

As depicted in operation 80 of digital video delivery process 50 as shown in FIGS. 2A and 2B, web browser API tool 52 renders the most recent frame for display. Web browser 54 is AJAX tool 54 is configured to display the rendered most recent frame. Digital video delivery process is configured to only cache compete frames for rendering and display, thereby operating with relatively less bandwidth while delivering complete frames for rendering and display.

As part of second branch from operation 66, HTTP API 56 determines if a video client exists as shown in operation 82 of FIGS. 2A and 2B. If a video client does not exist, then a new video client is created as shown in operation 84 of FIGS. 2A and 2B. Once the new video client is created, then digital video may be streamed as shown in operation 86 of FIGS. 2A and 2B. As shown in operation 88, a video frame is received by video client 58. If the video frame is complete, the most recent image is updated in video cache as depicted by operation 90. Decision block 92 interrogates to determine if a video consumer exists. If a video consumer exists, digital video delivery process 50 loops to receive another digital frame. If a video consumer does not exist, then the video client exits as shown by operation 94.

Digital video delivery process 50 may be a threaded process for a relatively large number of video streams (e.g., 10 to 100) such that a display interface may have a relatively large number of windows, each displaying a different live video feed without low quality frames being displayed. Therefore, the processes of one or more embodiments can be used to maintain the integrity of each of the video feeds.

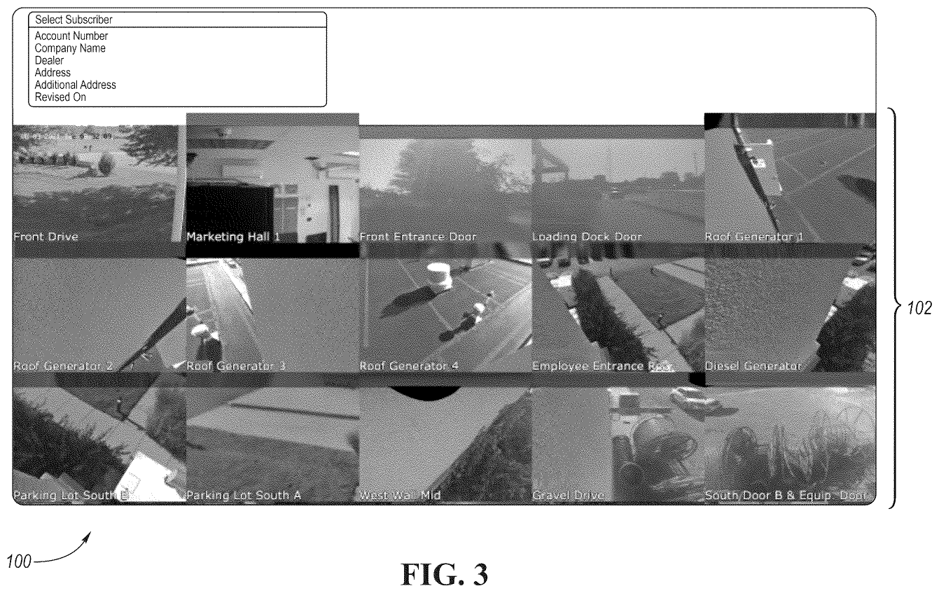

FIG. 3 depicts graphical user interface (GUI) 100 configured to display several windows 102 where each window contains a live video feed rendered using one or more embodiments disclosed herein. GUI 100 includes account number field 104 configured to receive an account number of a customer. Upon entering a valid account number, the company name and address of the customer is displayed. As shown in FIG. 3, fifteen (15) live video streams are displayed at once. In one or more embodiments, the term “live” may be referred to as “pseudo-live” because a time lag may exist between the most recent frame in time versus the most recent complete frame in time. In one or more embodiments, only the most recent complete frame in time is rendered and displayed to maintain the integrity of all the “live” feeds. In one or more embodiments, the display frame rate may be decreased in response to the available bandwidth and/or processing power of the user's computer executing GUI 100.

The following applications are related to the present application: U.S. patent application Ser. No. 17/232,284, filed on Apr. 16, 2021, U.S. patent application Ser. No. 17/232,247, filed on Apr. 16, 2021, U.S. patent application Ser. No. 17/232,261, filed on Apr. 16, 2021, U.S. patent application Ser. No. 17/232,266, filed on Apr. 16, 2021, U.S. patent application Ser. No. 17/232,275, filed on Apr. 16, 2021, U.S. patent application Ser. No. 17/232,296, filed on Apr. 16, 2021, and U.S. patent application Ser. No. 17/675,673, filed Jun. 17, 2022, which are each incorporated by reference in their entirety herein.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

Any combination of computer-readable media may be utilized to implement the systems and processes of any embodiment disclosed herein. Computer-readable media may be a computer-readable signal medium and/or a computer-readable storage medium. A computer-readable storage medium may include any suitable tangible medium that can contain or store a program for use by or in connection with an instruction execution system, apparatus, or device. A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device. Program code embodied on a computer-readable medium may be transmitted using any appropriate medium, including but not limited to wireless, optical fiber cable, RF, and/or the like, and/or any suitable combinations thereof. Computer program code for carrying out operations for aspects of the systems described herein may be written in one or any combination of programming language such as Java, Smalltalk, C++, and conventional procedural programming languages, such as C. Mobile apps may be developed using any suitable language, including those previously mentioned, as well as Objective-C, Swift, c #, and HTML5.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer readable medium having non-transitory memory for storing machine instructions that are to be executed by a digital video delivery alarm computer, the machine instructions when executed by the digital video alarm computer implement the following functions:
determining a receipt frame rate for receiving digital video frames including first and second digital video frames by the digital video delivery alarm computer from a digital video transmitting computer having a transmit frame rate for transmitting digital video frames including the first and second digital video frames; and
adjusting a display frame rate for displaying the digital video frames including the first and second digital video frames through the digital video delivery alarm computer in response to the receipt frame rate, the display frame rate is less than the transmit frame rate, and the digital video frames are associated with a digital video event.

2. The computer readable medium of claim 1, wherein adjusting function is executed at a first time and at a second time to determine a first display rate and a second display rate different than the first display rate.

3. The computer readable medium of claim 1, wherein the first and second digital video frames are first and second complete digital video frames.

4. The computer readable medium of claim 1, wherein the first and second digital video frames are first and second digital video reference frames.

5. The computer readable medium of claim 1, wherein the machine instructions when executed by the digital video alarm computer implement the following further function: displaying the first and second digital video frames within a first display window on the digital video alarm computer.

6. The computer readable medium of claim 1, wherein the first and second digital video frames are not incomplete digital video frames.

7. The computer readable medium of claim 1, wherein the first and second digital video frames are not sequential in time.

8. A computer readable medium having non-transitory memory for storing machine instructions that are to be executed by a digital video delivery alarm computer, the machine instructions when executed by the digital video alarm computer implement the following functions:
receiving a digital video frame;
storing the digital video frame in a video cache upon determining the digital video frame is a complete digital video frame;
accessing the digital video frame to render the digital video frame to create a rendered digital video frame; and
displaying the rendered digital video frame.

9. The computer readable medium of claim 8, wherein the digital video frame is part of a digital video stream.

10. The computer readable medium of claim 8, wherein the digital video frame is received by a hypertext transfer protocol (HTTP) application programming interface (API).

11. The computer readable medium of claim 8, wherein the machine instructions when executed by the digital video alarm computer implement the following further function: serving the digital video frame to transmit the digital video frame.

12. The computer readable medium of claim 11, wherein the digital video frame is served by the video cache.

13. The computer readable medium of claim 11, wherein the digital video frame is transmitted to a hypertext transfer protocol (HTTP) application programming interface (API).

14. The computer readable medium of claim 8, wherein the rendered digital video frame is rendered by a web browser application programming interface (API).

15. A computer readable medium having non-transitory memory for storing machine instructions that are to be executed by a digital video delivery alarm computer, the machine instructions when executed by the digital video alarm computer implement the following functions:
receiving a first video stream and a second video stream, the first video stream including a number of first digital video frames and the second video stream including a number of second digital video frames;
selectively displaying the number of first digital video frames in a first window at a first display frame rate such that the displayed first digital video frames in the number of first digital video frames are complete first digital video frames; and
selectively displaying the number of second digital video frames in a second window at a second display frame rate such that the displayed second digital video frames in the number of second digital video frames are complete second digital video frames.

16. The computer readable medium of claim 15, wherein the displayed first digital video frames are displayed from a video cache, and the displayed second digital video frames are displayed from the video cache.

17. The computer readable medium of claim 15, wherein the complete first digital video frames are reference first digital video frames, and the compete second digital video frames are reference second digital video frames.

18. The computer readable medium of claim 16, wherein the machine instructions when executed by the digital video alarm computer implement the following further function: determining whether one or more digital video frames of the number of first digital video frames are incomplete, and the incomplete first digital video frames are not included in the displayed first digital video frames.

19. The computer readable medium of claim 18, wherein the incomplete first digital video frames are not stored in the video cache.

20. The computer readable medium of claim 15, wherein the first display frame rate is decreased in response to an available bandwidth and/or processing power of digital video alarm computer.
